(19) United States
(12) Patent Application Publication
(10) Pub. No.: US 2013/0100865 A1
(43) Pub. Date: Apr. 25, 2013

(54) METHOD AND SYSTEM OF AGGREGATING COMPONENT CARRIERS ACROSS FREQUENCY BANDS

(71) Applicants: Sudhir Kumar Baghel, Gyeonggi-do (KR); Gert-Jan Van Lieshout, Middlesex (IN); Nitin Jain, Bangalore (IN)

(72) Inventors: Sudhir Kumar Baghel, Gyeonggi-do (KR); Gert-Jan Van Lieshout, Middlesex (IN); Nitin Jain, Bangalore (IN)

(21) Appl. No.: 13/805,931

(22) PCT Filed: Jun. 21, 2011
(86) PCT No.: PCT/KR11/04531

§ 371 Date: Dec. 20, 2012

(30) Foreign Application Priority Data
Jun. 21, 2010 (IN) 1737/CHE/2010

(51) Int. Cl. H04W 72/04

(52) U.S. Cl. CPC H04W 72/04
USPC 370/280; 370/329; 370/312; 370/281

(57) ABSTRACT

A method and system for aggregating component carriers across frequency bands are provided. The method includes aggregating a DL carrier of a first cell associated with a first frequency band with an UpLink (UL) carrier of a second cell associated with a second band, wherein the first cell includes an aggregated downlink carrier and an unused uplink carrier; communicating cross-linking information for carrier aggregation associated with the DL carrier of the first frequency band with the UL carrier of the second frequency band to a plurality of user equipments; and performing data transfer with each of the plurality of user equipments using the aggregated DL carrier of the first frequency band and the UL carrier of the second frequency band.

### PRIORITY

This application is a National Phase Entry of PCT International Application No. PCT/KR2011/004531, which was filed on Jun. 21, 2011, and claims priority to Indian Patent Application Serial No. 1737/CHE/2010, which was filed in the Indian Intellectual Property Office on Jun. 21, 2010, the entire content of each of which is incorporated herein by reference.

### BACKGROUND OF THE INVENTION

1. Field of the Invention

The present invention relates generally to wireless communication, and more particularly, to aggregating component carriers across frequency bands in a wireless network environment.

2. Description of the Related Art

Wireless communication systems are widely deployed to provide various communication services such as voice, video, packet data, broadcast, messaging, etc. These systems include multiple-access systems that are capable of supporting communication for multiple users by sharing the available system resources.

Recently, in wireless communication technologies such as Long Term Evolution (LTE)/LTE Advanced (LTE-A), carrier aggregation has been introduced, such that two or more component carriers are aggregated in order to support wider transmission bandwidths up to 100 MHz. Carrier aggregation technique enables configuration of a user equipment to aggregate different number of cells including component carriers and possibly having different bandwidths in both uplink and downlink.

Different levels of carrier aggregation are possible based on availability of spectrum and traffic. It is known that DownLink (DL) and UpLink (UL) traffic load can differ significantly. This difference in traffic load necessitates a deployment of more DL carriers than UL carriers. Currently, an operator is allowed to deploy its network with more downlink component carriers than uplink component carriers present in the same frequency band. However, the operator is not allowed to crosslink a DL carrier from one frequency band with UL carrier from a different frequency band. If carrier aggregation allows cross-linking DL and UL carriers from different frequency bands, then the legacy user equipments must be aware about such configuration, since the legacy user equipments may not have desired radio capability to operate on such cells.

Also, a cell cannot be aggregated as a standalone DL carrier from a specific frequency band even when there is no requirement to have an uplink carrier in the cell. When the cell is used as the DL carrier only, the UE may be unaware that the cell does not have any uplink carriers and thus initiates idle mode procedures after camping on the cell.

However, this may lead to failure conditions due to an unavailability of uplink carriers in the cell.

### SUMMARY OF THE INVENTION

Accordingly, the present invention has been designed to address the above and other problems occurring in the prior art, and provide at least the advantages described below.

According to an aspect of the present invention, a method of aggregating DownLink (DL) carriers across frequency bands is provided. The method includes aggregating a DL carrier of a first cell associated with a first frequency band with an UpLink (UL) carrier of a second cell associated with a second frequency band, wherein the first cell includes an aggregated downlink carrier and an unused uplink carrier; providing cross-linking information associated with the DL carrier of the first frequency band aggregated with the UL carrier of the second frequency band to a plurality of user equipments; and communicating data with each of the plurality of user equipments using the aggregated DL carrier of the first frequency band and the UL carrier of the second frequency band.

According to another aspect of the present invention, a method of aggregating DownLink (DL) carriers across different frequency bands comprising: aggregating a DL carrier of a cell associated with a frequency band in order to operate as a standalone DL carrier; providing standalone information associated with the DL carrier of the frequency band; and communicating data with each of a plurality of user equipments using the aggregated DL carrier of the frequency band.

According to another aspect of the present invention, an apparatus is provided. The apparatus includes a processor; and memory coupled to the processor and configured to temporarily store instructions, that when executed by the processor, result in performing a method including aggregating a DownLink (DL) carrier of a first cell associated with a first frequency band with an UpLink (UL) carrier of a second cell associated with a second frequency band, wherein the first cell includes an aggregated downlink carrier and an unused uplink carrier; providing cross-linking information associated with the DL carrier of the first frequency band aggregated with the UL carrier of the second frequency band to a plurality of user equipments; and communicating data with each of the plurality of user equipments using the aggregated DL carrier of the first frequency band and the UL carrier of the second frequency band.

According to another aspect of the present invention, an apparatus is provided. The apparatus includes a processor; and memory coupled to the processor and configured to temporarily store instructions, that when executed by the processor, result in performing a method including aggregating a DownLink (DL) carrier of a cell associated with a frequency band in order to operate as a standalone DL carrier; providing standalone information associated with the DL carrier of the frequency band to a plurality of user equipments; and communicating data with each of the plurality of user equipments using the aggregated DL carrier of the frequency band.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a block diagram illustrating a wireless communication system for aggregating component carriers across frequency bands, according to an embodiment of the present invention.

FIG. 2 is a process flowchart illustrating a method for aggregating a DownLink (DL) carrier in a standalone manner, according to an embodiment of the present invention.

FIG. 3 is a process flowchart illustrating a method for aggregating a DL carrier in a cross-linked manner, according to an embodiment of the present invention.

FIGS. 4 and 5 are diagrams illustrating a schematic representation of aggregating a downlink carrier in a standalone and cross-linked manner, according to an embodiment of the present invention.

FIG. 6 is a block diagram illustrating a base station showing various components for implementing embodiments of the present invention.

### DETAILED DESCRIPTION OF EMBODIMENTS OF THE PRESENT INVENTION

Embodiments of the present invention include a method and system for aggregating component carriers across frequency bands. Embodiments of the present invention are described in detail hereinafter with reference to the accompanying drawings. In the following description, the same drawing reference numerals may be used for the same or similar elements even in different drawings. Additionally, a detailed description of known functions and configurations incorporated herein may be omitted when such a description may obscure the subject matter of the present invention.

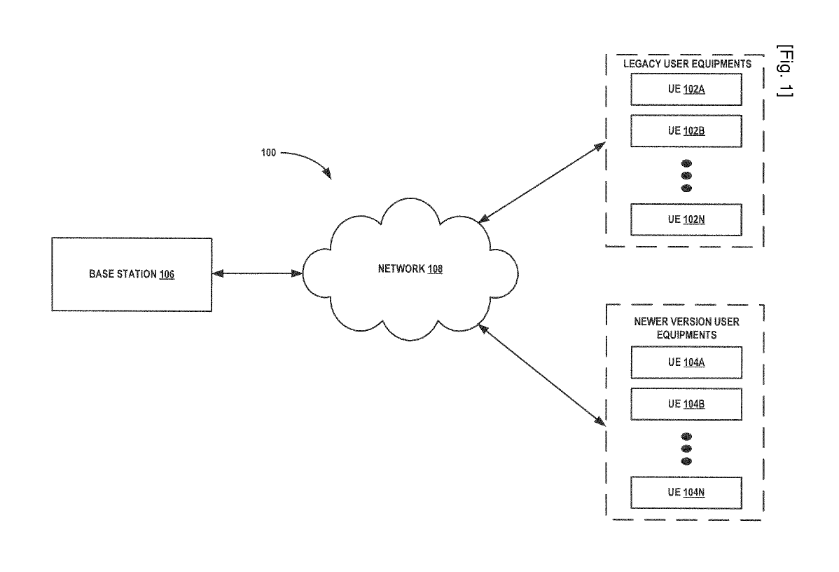

FIG. 1 is a block diagram illustrating wireless communication system for aggregating component carriers across frequency bands, according to an embodiment of the present invention.

Referring to FIG. 1, a wireless communication system 100 includes a set of legacy user equipments 102A-102N, a set of newer version of user equipments 104A-104N and a base station 106 connected to the user equipments 102A-102N and 104A-104N via a network 108. For example, in LTE technology, the legacy user equipments 102A-102N include user equipments that support release 8 and release 9 version of LTE system, whereas the newer version of user equipments are devices associated with release 10 or higher version of LTE system that support cross-linking of component carriers.

According to an embodiment of the present invention, the base station 106 enables network operators to asymmetrically aggregate a DL carrier of a frequency band. For example, the base station 106 enables aggregation of carriers when there is need to deploy more DL carriers than UL carriers in a cell.

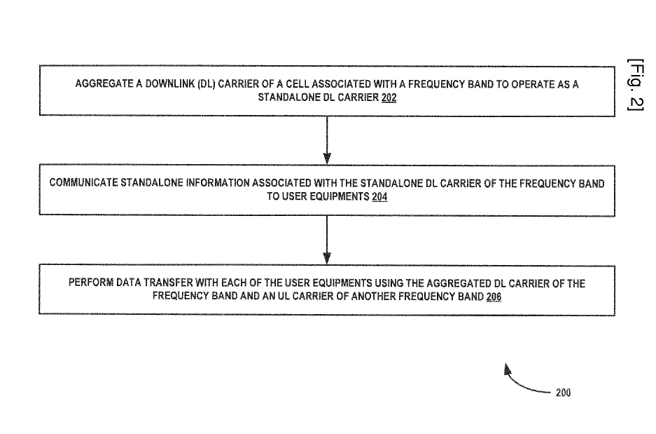

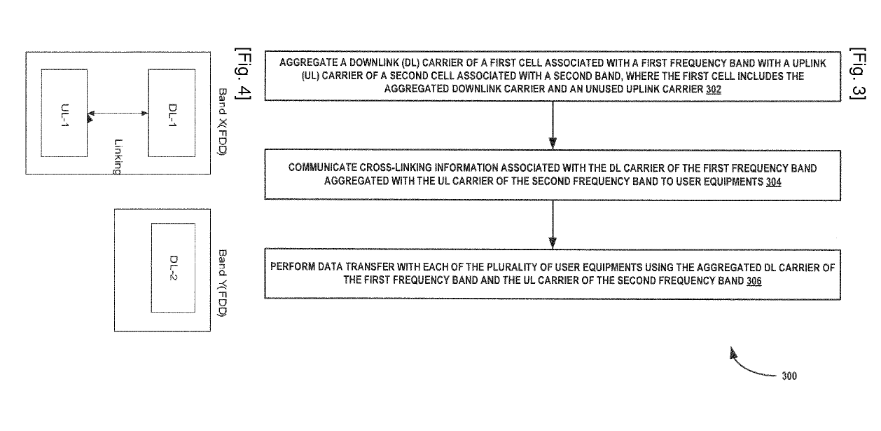

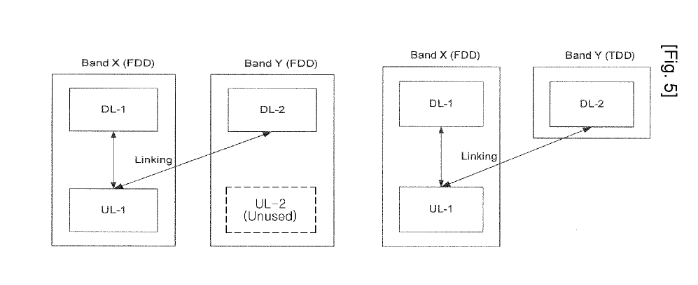

According to an embodiment of the present invention, the base station 106 aggregates a DL carrier associated with a frequency band in a standalone manner as illustrated in FIG. 4A. According to another embodiment of the present invention, the base station 106 aggregates a DL carrier associated with a frequency band with an UL carrier associated with another frequency band in a cross-linked manner as illustrated in FIG. 4B. The process of aggregating one or more DL carriers across frequency bands in a standalone manner and a cross-linked manner is illustrated in FIGS. 2 and 3, respectively.

FIG. 2 is a process flowchart illustrating a method for aggregating DL carrier in a standalone manner, according an embodiment of the present invention.

Referring to FIG. 2, at step 202 of flowchart 200, a DL carrier of a standalone cell associated with a frequency band is aggregated to operate as standalone downlink carrier. The standalone cell includes only a DL carrier, but does not include a UL carrier. The frequency band can be a dummy frequency band (e.g., a Frequency Division Duplexing (FDD) band) or a reused frequency band (e.g., an FDD band or a Time Division Duplexing (TDD) band).

At step 204, standalone information associated with the aggregated DL carrier of the frequency band is communicated to at least one user equipment 102A-102N and 104A-104N. The standalone information includes a frequency band indicator, frequency band information, Evolved Universal Mobile Telecommunications System (UMTS) Terrestrial Radio Access (EUTRA) Absolute Radio Frequency Channel Number (EARFCN) value, and barred cell information. For example, the frequency band indicator includes a dummy band value indicating that the DL carrier of the frequency band is aggregated as a standalone DL carrier. The frequency band information indicates the frequency band associated with the DL and UL carriers. The EARFCN value corresponds to a special value that not currently being used by any frequency band. By reading the EARFCN value, the user equipments 102A-102N and 104A-104N determine that the value is associated with the standalone DL carrier, and therefore determine that the UL frequency is not to be calculated. Also, the EARFCN value indicates that UL transmission for a corresponding standalone DL carrier should occur through another cell (e.g., the second cell). The barred cell information indicates that the standalone cell is barred from camping by the legacy user equipments 102A-102N.

According to an embodiment of the present invention, the standalone information is broadcast to the legacy and newer version user equipments 102A-102N and 104A-104N by the standalone cell in Master Information Block (MIB), System Information Block1(SIB1) and/or System Information Block2(SIB2). The user equipments 102A-102N and 104A-104N, upon receiving the standalone information, avoid camping on the standalone cell with the aggregated DL carrier in idle mode. This is achieved through communicating barred cell information in the SIB1 and invalid EARFCN values in the SIB2, or by not communicating information necessary for camping. Thus, when the user equipments 102A-102N and 104A-104N scan for a cell and find the standalone cell (e.g., from the capability list, and from the dummy band value in the SIB1), the user equipments 102A-102N and 104A-104N ignore the standalone cell with aggregated DL carrier (if found) for camping by reading the barred cell information, or invalid EARFCN values in the broadcast message.

During the connected mode, the newer version user equipments 104A-104N aggregate the DL carrier of the frequency band based on the dummy band value in the SIB1. According another embodiment of the present invention, the base station 106 sends a dedicated message carrying the standalone information to subset of the newer version user equipments 104A-104N. Accordingly, the subset of newer version user equipments 104A-104N links the DL carrier of the first frequency band with the UL carrier of the second frequency band based on the standalone information received in the dedicated message.

Based on the above, at step 206, a data transfer is performed with subset or all of the newer version user equipments 104A-104N using the DL carrier associated with the frequency band and the UL carrier associated with another frequency band.

FIG. 3 is a process flowchart illustrating a method for aggregating a DL carrier in a cross-linked manner, according to an embodiment of the present invention.

Referring to FIG. 3, at step 302 of flowchart 300, a DL carrier of a first cell associated with a first frequency band is aggregated with an UL carrier of a second cell associated with a second frequency band. The first cell includes only DL carrier and an unused UL carrier. The first frequency band can be a dummy frequency band (e.g., an FDD band) or a reused frequency band (e.g., an FDD band or a TDD band).

At step 304, cross-linking information for carrier aggregation of the DL carrier of the first frequency band with the UL carrier of the second frequency band is communicated to one or more user equipments 102A-102N and 104A-104N. The cross-linking information includes a frequency band indicator (in SIB1), frequency band information, EARFCN value, and barred cell information. For example, the frequency band indicator includes a dummy band value indicating that the DL carrier of the first frequency band is aggregated with the UL carrier of the second frequency band. The frequency band information indicates the frequency band associated with the DL and UL carriers. The EARFCN value corresponds to a special value not being currently used by any frequency band. By reading the EARFCN value, the user equipments 102A-102N and 104A-104N determine that the value is associated with the aggregated DL carrier, and therefore determine that the associated UL frequency is not to be calculated.

According to an embodiment of the present invention, the cross-linking information is broadcast to the legacy and newer version user equipments 102A-102N and 104A-104N by the DL carrier in a MIB, SIB1 and SIB2. The frequency band indicator is indicated in the SIB1 for cross-linking DL carrier with the UL carrier. According to one example, the frequency band indicator avoids legacy user equipments 102A-102N to camp on cross-linked DL carrier, whereas the newer version user equipments 104A-104N can select the cross-linked DL carrier for camping. In another exemplary implementation, the frequency band indicator in the SIB1 may indicate a frequency band value associated with the uplink carrier instead of DL carrier. Enhancements in the legacy user equipments 102A-102N can enable the user equipments 102A-102N to support cross-linked DL carriers.

The SIB2 also carries the EARFCN corresponding to the UL carrier such that the newer version user equipments 104A-N can unambiguously determine the second frequency band associated with the UL carrier from the EARFCN value. The second frequency band associated with the UL carrier can be determined based on the EARFCN value, as the EARFCN numbers are non-overlapping across frequency bands. Moreover, the SIB2 include the release 10 specific extension indicating the first frequency band associated with the aggregated DL carrier. Thus, the newer version user equipments 104A-104N can interpret the first frequency band from the extension and calculate the DL frequency using techniques well known persons having ordinary skill in the art. In another approach according to an embodiment of the present invention, the release 10 specific extension may be included in the SIB1 to indicate asymmetric operation.

The legacy user equipments 102A-102N, upon receiving the cross-linking information, avoid camping on the first cell with the aggregated DL carrier in idle mode and connected mode. This is achieved through communicating barred cell information and invalid EARFCN values, or by not communicating information necessary for camping. Thus, when the legacy user equipments 102A-102N scan for a cell and find the first cell, the legacy user equipments 102A-102N ignore a first cell with aggregated DL carrier (if found) for camping by reading the barred cell information, or invalid EARFCN values in the broadcast message.

However, the newer version user equipments 104A-104N, upon reading the broadcast message, camp on the first cell with the aggregated DL carrier. In the connected mode, the newer version user equipments 104A-104N cross link the DL carrier of the first frequency band with the UL carrier of the second frequency band based on the cross-linking information received in the broadcast message. According to another embodiment of the present invention, the base station 106 sends a dedicated message carrying the cross-linking information to subset of the newer version user equipments 104A-104N. Accordingly, the subset of newer version user equipments 104A-104N cross links the DL carrier of the first frequency band with the UL carrier of the second frequency band based on the cross-linking information received in the dedicated message.

Based on the above, at step 306, a data transfer is performed with subset or all of the newer version user equipments 104A-104N using the DL carrier associated with the first frequency band and the UL carrier associated with the second frequency band.

FIGS. 4 and 5 are diagrams illustrating a schematic representation of aggregating downlink carrier in a standalone and cross-linked manner, according to an embodiment of the present invention. In FIG. 4, a DL carrier in Band Y is aggregated in a standalone manner. Through this form of aggregation, the newer version user equipments 104A-104N can receive downlink data through the DL carrier of Band Y and send uplink data through the UL carrier of Band X. In FIG. 5, a DL carrier in Band Y is cross linked with an UL carrier of Band X, while an UL carrier of the Band Y is unused. Through this arrangement, the newer version user equipments 104A-104N can receive downlink data through the DL carrier of Band Y and send uplink data through the UL carrier of Band X. In another approach, the Band Y such as TDD band having a single carrier used as additional downlink carrier and is aggregated with the UL carrier of Band X.

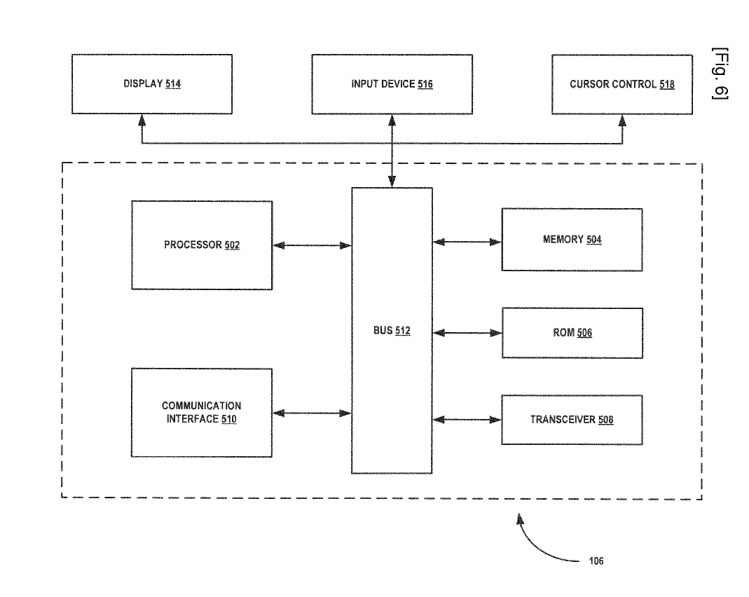

FIG. 6 is a block diagram of a base station according to an embodiment of the present invention.

Referring to FIG. 6, the base station 106 includes a processor 502, memory 504, a Read Only Memory (ROM) 506, a transceiver 508, a bus 510, a communication interface 512, a display 514, an input device 516, and a cursor control 518.

The processor 502, as used herein, refers to any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 502 may also include embedded controllers, such as generic or programmable logic devices or arrays, application specific integrated circuits, single-chip computers, smart cards, and the like.

The memory 504 and the ROM 506 may be volatile memory and non-volatile memory. The memory 504 includes instructions temporarily stored therein for aggregating component carriers across frequency bands, according to one or more embodiments described above. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, etc.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 502. For example, a computer program according to embodiments of the present invention may include machine-readable instructions capable of aggregating component carrier across bands, according to embodiments of the present invention. According to an embodiment of the present invention, the program may be included on a compact disk-read only memory (CD-ROM) and loaded from the CD-ROM to a hard drive in the non-volatile memory. The machine-readable instructions may cause the base station 106 to encode according to the various embodiments of the present invention.

The transceiver 508 may communicate cross-linking/standalone information and perform data transfer with the user equipments using the aggregated DL carrier from a frequency band and a UL carrier of another frequency band. The bus 510 interconnects between various components of the base station 106. The components such as communication interfaces 512, the display 514, the input device 516, and the cursor control 518 are well known to the person skilled in the art, and therefore an explanation of these components is omitted to avoid obscuring the subject matter of the present invention.

Although, the above-described methods and system refer to aggregation of the DL carrier(s) in a standalone and cross-linked manner, UL link carriers can also be aggregated in a standalone and cross-linked fashion in a manner similar to that described above, in accordance with embodiments of the present invention.

Although embodiments of the present invention have been described with reference to specific examples, various modifications and changes may be made to these embodiments without departing from the broader spirit and scope of the present invention. Furthermore, the various devices, modules, selectors, estimators, and the like described herein may be enabled and operated using hardware circuitry, for example, complementary metal oxide semiconductor based logic circuitry, firmware, software and/or any combination of hardware, firmware, and/or software embodied in a machine readable medium, in accordance with embodiments of the present invention. For example, the various electrical structure and methods may be embodied using transistors, logic gates, and electrical circuits, such as application specific integrated circuit.

While the present invention has been shown and described with reference to certain embodiments thereof, it will be understood by those skilled in the art that various changes in form and details may be made therein without departing from the spirit and scope of the present invention as defined by the appended claims and their equivalents.

1. A method of aggregating DownLink (DL) carriers across frequency bands, the method comprising:
aggregating a DL carrier of a first cell associated with a first frequency band with an UpLink (UL) carrier of a second cell associated with a second frequency band, wherein the first cell includes an aggregated downlink carrier and an unused uplink carrier;
providing cross-linking information associated with the DL carrier of the first frequency band aggregated with the UL carrier of the second frequency band to a plurality of user equipments; and
communicating data with each of the plurality of user equipments using the aggregated DL carrier of the first frequency band and the UL carrier of the second frequency band.

2. The method of claim 1, wherein the cross-linking information includes at least one of a frequency band indicator, frequency band information, an Evolved Universal Mobile Telecommunications System (UMTS) Terrestrial Radio Access (EUTRA) Absolute Radio Frequency Channel Number (EARFCN), and barred cell information.

3. The method of claim 2, wherein the plurality of user equipments includes legacy user equipments and newer version user equipments being different from the legacy user equipments.

4. (canceled)

5. The method of claim 3, wherein providing the cross-linking information associated with the DL carrier of the first frequency band aggregated with the UL carrier of the second frequency band to the plurality of user equipments further comprises:
broadcasting the cross-linking information to the legacy user equipments such that the legacy user equipments avoid camping on the first cell associated with the aggregated DL carrier during an idle mode based on the cross-linking information.

6. The method of claim 3, wherein providing the cross-linking information associated with the DL carrier of the first frequency band aggregated with the UL carrier of the second frequency band to the plurality of user equipments further comprises:
broadcasting the cross-linking information to the newer version equipments such that the newer version user equipments camps on the first cell associated with the aggregated DL carrier during an idle mode.

7. The method of claim 3, wherein broadcasting the cross-linking information associated with the DL carrier of the first frequency band aggregated with the UL carrier of the second frequency band to the plurality of user equipments further comprises:
broadcasting the cross-linking information to the newer version user equipments such that the newer version user equipments links the DL carrier of the first frequency band and the UL carrier of the second frequency band during connected mode based on the cross-linking information.

8. The method of claim 1, wherein providing the cross-linking information associated with the DL carrier of the first frequency band aggregated with the UL carrier of the second frequency band to the plurality of user equipments further comprises:
communicating the cross-linking information to at least one of the newer version user equipments via dedicated signalling such that the one or more of the newer version user equipments links the DL carrier of the first frequency band and the UL carrier of the second frequency band during connected mode using the cross-linking information.

9. The method of claim 2, wherein the frequency band indicator includes a dummy band value indicating that the DL carrier of the first frequency band is aggregated with the UL carrier of the second frequency band.

10. The method of claim 1, wherein the first frequency band includes a dummy frequency band or a re-used frequency band.

11. The method of claim 9, wherein the dummy frequency band is a Frequency Division Duplexing (FDD) band.

12. The method of claim 10, wherein the re-used frequency band is selected from the group consisting of a FDD band and a Time Division Duplexing (TDD) band.

13. A method of aggregating DownLink (DL) carriers across different frequency bands, the method comprising:
aggregating a DL carrier of a cell associated with a frequency band in order to operate as a standalone DL carrier;
providing standalone information associated with the DL carrier of the frequency band; and
communicating data with each of a plurality of user equipments using the aggregated DL carrier of the frequency band.

14. The method of claim 13, wherein the standalone information includes at least one of a frequency band indicator, frequency band information, an Evolved Universal Mobile Telecommunications System (UMTS) Terrestrial Radio Access (EUTRA) Absolute Radio Frequency Channel Number LEARFCN), and barred cell information.

15. The method of claim 14, wherein the plurality of user equipment includes legacy user equipments and newer version user equipments being different from the legacy user equipments.

16. The method of claim 15, wherein providing the standalone information associated with the DL carrier of the frequency band comprises:
broadcasting the standalone information associated with the DL carrier of the frequency band to the plurality of user equipments.

17. The method of claim 16, wherein broadcasting the standalone information associated with the DL carrier of the frequency band to the plurality of user equipments further comprises:
broadcasting the standalone information to the legacy user equipments such that the legacy user equipments and the newer version of user equipments avoid camping on the cell associated with the aggregated DL carrier during an idle mode based on the standalone information.

18. The method of claim 16, wherein broadcasting the standalone information associated with the DL carrier of the frequency band to the plurality of user equipments further comprises:
broadcasting the standalone information to the newer version user equipments such that the newer version user equipments can aggregate the DL carrier of the frequency band during connected mode.

19. The method of claim 13, wherein the frequency band indicator includes a dummy band value indicating the standalone DL carrier of the frequency band.

20. The method of claim 13, wherein the first frequency band includes a dummy frequency band or a re-used frequency band.

21. The method of claim 20, wherein the dummy frequency band is a Frequency Division Duplexing (FDD) band.

22. The method of claim 20, wherein the re-used frequency band is selected from a group consisting of an FDD band and a Time Division Duplexing TDD band.

23. An apparatus comprising:
a processor; and
a memory coupled to the processor and configured to temporarily store instructions, that when executed by the processor, result in performing a method comprising:
aggregating a DownLink (DL) carrier of a first cell associated with a first frequency band with an UpLink (UL) carrier of a second cell associated with a second frequency band, wherein the first cell includes an aggregated downlink carrier and an unused uplink carrier;
providing cross-linking information associated with the DL carrier of the first frequency band aggregated with the UL carrier of the second frequency band to a plurality of user equipments; and
communicating data with each of the plurality of user equipments using the aggregated DL carrier of the first frequency band and the UL carrier of the second frequency band.

24. The apparatus of claim 23, wherein the cross-linking information includes at least one of a frequency band indicator, frequency band information, an Evolved Universal Mobile Telecommunications System (UMTS) Terrestrial Radio Access (EUTRA) Absolute Radio Frequency Channel Number (EARFCN), and barred cell information.

25. The apparatus of claim 24, wherein the frequency band indicator includes a dummy band value indicating that the DL carrier of the first frequency band is aggregated with the UL carrier of the second frequency band.

26. An apparatus comprising:
a processor; and
a memory coupled to the processor and configured to temporarily store instructions, that when executed by the processor, result in performing a method comprising:
aggregating a DownLink (DL) carrier of a cell associated with a frequency band in order to operate as a standalone DL carrier;
providing standalone information associated with the DL carrier of the frequency band to a plurality of user equipments; and
communicating data with each of the plurality of user equipments using the aggregated DL carrier of the frequency band.

27. The apparatus of claim 23, wherein the standalone information includes at least one of a frequency band indicator, frequency band information, an Evolved Universal Mobile Telecommunications System (UMTS) Terrestrial Radio Access (EUTRA) Absolute Radio Frequency Channel Number (EARFCN), and barred cell information.

28. The apparatus of claim 24, wherein the frequency band indicator includes a dummy band value indicating that the standalone DL carrier of the frequency band.
